(19) United States
(12) Patent Application Publication
(10) Pub. No.: US 2024/0272337 A1
(43) Pub. Date: Aug. 15, 2024

(54) DISPLAY PANEL AND MANUFACTURING METHOD THEREOF

(71) Applicant: BOE TECHNOLOGY GROUP CO., LTD., Beijing (CN)

(72) Inventors: Mengya Song, Beijing (CN); Dongfei Hou, Beijing (CN); Qian Wu, Beijing (CN); Duohui Li, Beijing (CN); Kang Guo, Beijing (CN); Xin Gu, Beijing (CN); Dacheng Zhang, Beijing (CN)

(73) Assignee: BOE TECHNOLOGY GROUP CO., LTD., Beijing (CN)

(21) Appl. No.: 18/022,552

(22) PCT Filed: May 30, 2022
(86) PCT No.: PCT/CN2022/095950

§ 371 Date: Feb. 22, 2023

(51) Int. Cl. G02B 3/08; G02B 3/00

(52) U.S. Cl. CPC G02B 3/08; G02B 2003/0093; G02B 2207/101

(57) ABSTRACT

This disclosure relates to a display panel, including a display panel main body and a light modulation structure on a light-emitting side of the display panel main body, where the display panel main body includes pixels; the light modulation structure includes a substrate, a first medium, a second medium, and a cover layer; the first medium includes a metasurface structure including multiple metasurface structural units arranged on a surface of the substrate close to the cover layer, the metasurface structural units are in one-to-one correspondence with the pixels and each include multiple nano-pillars; the second medium includes a gas layer filling between the substrate and the cover layer, which are spaced from each other by support pillars, and a height of the support pillars is greater than that of the nano-pillars in a direction perpendicular to the substrate. This disclosure also relates to a method for manufacturing a display panel.

### TECHNICAL FIELD

The present disclosure relates to the field of display product manufacturing technologies, in particular to a display panel and a manufacturing method thereof.

### BACKGROUND

Traditional optical elements are usually composed of continuous curved surfaces. Due to the limitations of the refractive index of materials, mechanical processing technology, and other factors, the light wave modulation ability of the traditional optical elements is usually continuous and limited in range, and the element thickness is also large. Metasurface technique aims at breaking the limitation of traditional optical materials by using sub-wavelength micro structural elements, to realize abrupt modulation of phase, amplitude and polarization, and may integrate these structures in a plane, to greatly reduce the thickness of the device, and has optical performance advantages: a monochromatic metasurface lens can achieve a numerical aperture NA=0.8 and an efficiency greater than 80%, and theoretically, it can achieve arbitrary phase distribution in a plane.

In the related art, the metasurface structure includes a substrate and nano-pillars disposed on the substrate. In order to realize light modulation, the metasurface structure generally needs to be encapsulated for protection. In order not to destroy the light modulation function of the metasurface lens, a layer of low refractive index adhesive material or other low refractive index material is generally coated on the surface of the nano-pillars, and then a cover glass is attached for protection. The low refractive index adhesive material or other low refractive index material may enter between adjacent nano-pillars, or even cover the nano-pillars, which affects the optical effect.

### SUMMARY

In order to solve the above-mentioned technical problems, the present disclosure provides a display panel and a manufacturing method thereof, which solves the problem that the low refractive index adhesive layer may affect the optical effect.

In order to achieve the above object, the embodiments of the present disclosure adopt the following technical solutions: a display panel including a display panel main body and a light modulation structure located on a light-emitting side of the display panel main body;
where the display panel main body includes a plurality of pixels arranged in an array;
the light modulation structure includes a substrate, a first medium, a second medium, and a cover layer, the first medium and the second medium are disposed between the substrate and the cover layer;
the first medium includes a metasurface structure, the metasurface structure includes a plurality of metasurface structural units arranged in an array on the surface of the substrate close to the cover layer, the plurality of metasurface structural units are in one-to-one correspondence with the plurality of pixels, and each of the metasurface structural units includes a plurality of nano-pillars spaced apart;
the second medium includes a gas layer filling between the substrate and the cover layer;
the substrate and the cover layer are spaced from each other by support pillars, and a height of the support pillars is greater than that of the nano-pillars in a direction perpendicular to the substrate.

Optionally, a refractive index of the nano-pillars is greater than that of the gas layer.

Optionally, a difference between the refractive index of the nano-pillars and the refractive index of the gas layer is greater than 0.7.

Optionally, a light-emitting surface of the display panel main body is located on a focal plane of the metasurface structure.

Optionally, a thickness of the substrate is greater than that of the metasurface structure in the direction perpendicular to the substrate.

Optionally, a distance between two adjacent metasurface structural units of the metasurface structural units is greater than a distance between two adjacent nano-pillars of the nano-pillars in each of the metasurface structural units.

Optionally, the nano-pillars in each of the metasurface structural units are symmetrically arranged about a center of the corresponding metasurface structural unit.

Optionally, a cross-section shape of the nano-pillars in the direction perpendicular to the substrate includes one or more of a rectangle, a circular arc, and a trapezoid.

Optionally, in the direction perpendicular to the substrate, the cross-section shape of the nano-pillars is a rectangle, the cross-section shape of the support pillars is a trapezoid, and a slope angle of the support pillars is less than that of the nano-pillars.

Optionally, an area of an orthographic projection of the support pillar onto the substrate is greater than an area of an orthographic projection of the nano-pillar onto the substrate.

Optionally, each of the pixels includes a plurality of sub-pixels, each of the metasurface structure units includes a plurality of sub-structural units, each of the sub-structural units includes a plurality of nano-pillars spaced apart, and the plurality of sub-structural units are in one-to-one correspondence with the plurality of sub-pixels.

Optionally, the pixel includes a plurality of different colored sub-pixels; and the nano-pillars within the metasurface structural unit that correspond to the different colored sub-pixels respectively have different arrangement spacings.

Optionally, the pixel includes a red sub-pixel, a green sub-pixel, and a blue sub-pixel;
the metasurface structural unit includes a first sub-structural unit corresponding to the red sub-pixel, and the arrangement spacing of the nano-pillars in the first sub-structural unit is 300-700 nm;
the metasurface structural unit includes a second sub-structural unit corresponding to the green sub-pixel, and the arrangement spacing of the nano-pillars in the second sub-structural unit is 270-550 nm;
the metasurface structural unit includes a third sub-structural unit corresponding to the blue sub-pixel, and the arrangement spacing of the nano-pillars in the third sub-structural unit is 230-450 nm.

Optionally, at least one of the support pillars is disposed on a peripheral edge of each of the sub-structural units.

Optionally, the substrate includes a central area where multiple metasurface structural units of the metasurface structural units are disposed, and an edge region at the periphery of the central area, and multiple support pillars of the support pillars are uniformly disposed in the edge area.

Optionally, the nano-pillars are made of silicon nitride, and the gas layer is an air layer.

Optionally, the support pillars are made of the same material as the nano-pillars.

The embodiments of the present disclosure also provide a method for manufacturing the above display panel, specifically including;
providing the display panel main body and the light modulation structure;
attaching the light modulation structure to a light-emitting side of the display panel main body; or
forming the substrate on the display panel main body;
forming the metasurface structure on the substrate, where the metasurface structure includes a plurality of metasurface structural units arranged in an array, the plurality of metasurface structural units are in one-to-one correspondence with a plurality of pixels on the display panel main body, and each of the metasurface structural units includes a plurality of nano-pillars;
forming a plurality of support pillars on the substrate;
forming on the substrate a filling layer filling between the adjacent nano-pillars, between the adjacent support pillars, and/or between the adjacent nano-pillar and support pillar, a side surface of the filling layer away from the substrate being flush with an end surface of the support pillars away from the substrate, where the filling layer is formed using a pore-forming agent material;
forming the cover layer on the filling layer;
heating to a preset temperature, causing the filling layer to gasify and escape through the cover layer while outside air enters between the substrate and the cover layer; and
forming a frame sealing adhesive around the substrate and the cover layer, and encapsulating the substrate and the cover layer together.

The beneficial effects of the present disclosure are as follows: the metasurface structure in the embodiments includes a substrate and a cover layer disposed oppositely, and a first medium and a second medium located between the substrate and the cover layer, where a gas layer is used as the second medium, and a gap exists between the cover layer and the first medium due to the arrangement of the support pillars between the substrate and the cover layer, which, compared with the arrangement of the low refractive index adhesive layer, avoids the problem that the low refractive index adhesive layer enters the first medium and affects the optical effect.

### BRIEF DESCRIPTION OF THE DRAWINGS

FIG. 1 is a schematic diagram of a metasurface structure in the related art;

FIG. 2 is a structure diagram of a metasurface structure after a low refractive index adhesive layer is disposed in the related art;

FIG. 3 is a structure diagram of a light modulation structure according to an embodiment of the present disclosure;

FIG. 4 is another structure diagram of a light modulation structure according to an embodiment of the present disclosure;

FIG. 5 is a structure diagram of a display panel according to an embodiment of the present disclosure;

FIG. 6 is another structure diagram of a display panel according to an embodiment of the present disclosure;

FIG. 7 is a schematic diagram showing a state after metasurface structural units are formed on a substrate according to an embodiment of the present disclosure;

FIG. 8 is a schematic diagram showing a state after support pillars are formed on the substrate according to an embodiment of the present disclosure;

FIG. 9 is a structure diagram of a cover layer on which support pillars are formed according to an embodiment of the present disclosure;

FIG. 10 is another schematic diagram showing a state after support pillars are formed on the substrate according to an embodiment of the present disclosure;

FIG. 11 is another structure diagram of a cover layer on which support pillars are formed according to an embodiment of the present disclosure;

FIG. 12 is a schematic diagram showing a state after a filling layer is formed on the substrate according to an embodiment of the present disclosure;

FIG. 13 is a schematic diagram showing a state after a cover layer is formed on the filling layer according to an embodiment of the present disclosure; and

FIG. 14 is still another structural diagram of a light modulation structure according to an embodiment of the present disclosure.

### DETAILED DESCRIPTION

In order to make the purpose, technical scheme and advantages of the embodiment of the present disclosure clearer, the technical scheme of the embodiment of the present disclosure will be described clearly and thoroughly with reference to the accompanying drawings. Obviously, the described embodiment is a part of the embodiments of the present disclosure, not all embodiments. Based on the described embodiments of the present disclosure, all other embodiments obtained by those skilled in the art shall fall within the scope of the present disclosure.

In the description of the present disclosure, it should be noted that the orientation or positional relationships indicated by the terms “center”, “upper”, “lower”, “left”, “right”, “vertical”, “horizontal”, “inside”, “outside”, etc. are based on those shown in the drawings, which is only for the convenience of describing the present disclosure and simplifying the description, and does not indicate or imply that the referred devices or elements must have a specific orientation, or must be constructed and operated in a specific orientation, so they cannot be understood as limiting the present disclosure. In addition, the terms “first”, “second” and “third” are only used for descriptive purposes and cannot be understood as indicating or implying relative importance.

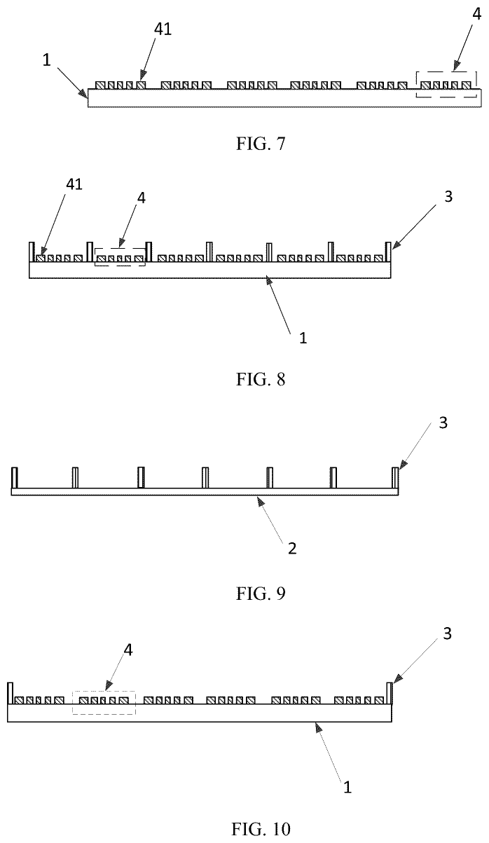

Referring to FIGS. 3 to 13, the embodiment provides a display panel, including a display panel main body and a light modulation structure located on a light-emitting side of the display panel main body;
where the display panel main body includes a plurality of pixels arranged in an array;
the light modulation structure includes a substrate 1, a first medium, a second medium, and a cover layer 2, the first medium and the second medium are disposed between the substrate 1 and the cover layer 2;
the first medium includes a metasurface structure, the metasurface structure includes a plurality of metasurface structural units 4 arranged in an array on a surface of the substrate 1 close to the cover layer 2, and each of the metasurface structural units 4 includes a plurality of nano-pillars 41 spaced apart from each other; the second medium includes a gas layer 5 filling between the substrate 1 and the cover layer 2;
the substrate 1 and the cover layer 2 are spaced from each other by the support pillars 3, and a height of the support pillars 3 is greater than a height of the nano-pillars 41 in a direction perpendicular to the substrate 1, so that there is a gap between the cover layer 2 and the metasurface structural units 4.

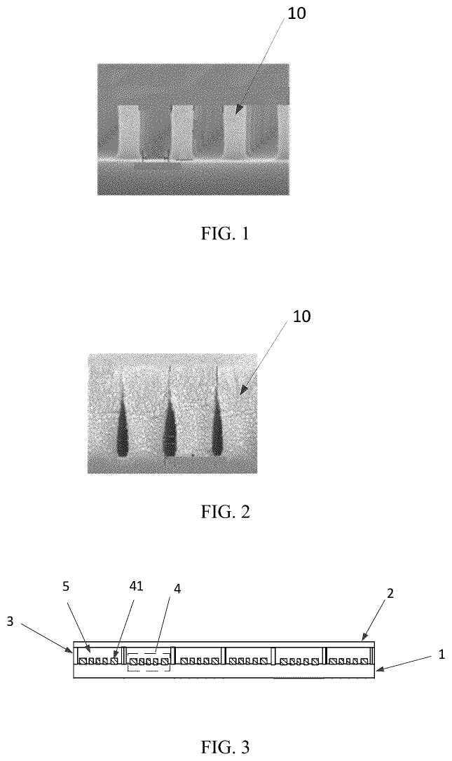

Referring to FIG. 1 and FIG. 2, a low refractive index adhesive layer is disposed on the metasurface structure including a plurality of nano-pillars, and the low refractive index adhesive layer enters between adjacent nano-pillars, and is coated on the surfaces of nano-pillars, which affects the optical effect. In contrast, in this embodiment, the gas layer 5 is used as the second medium, thus the distance between adjacent nano-pillars will not be changed; moreover, due to the arrangement of the support pillars 3, the cover layer 2 is prevented from contacting the metasurface structural units 4 and is prevented from pressing the nano-pillars to change the distance between adjacent nano-pillars, thereby the influence of the cover layer 2 on the refractive index difference between the first medium and the second medium can be avoided (there is a gap between the cover layer 2 and the first medium, so the optical path is refracted from the first medium (high refractive index medium) to the second medium (low refractive index medium), but if the cover layer is in contact with the first medium, the refraction of the optical path will be caused by the refractive index different between the first medium and the cover layer, thus changing the light refraction effect). The arrangement of the support pillars 3 and the cover layer 2 not only serves to protect the metasurface structural units 4, but also avoids the influence on the overall optical effect of the metasurface structure.

Illustratively, the height of the nano-pillars 41 is 800-900 nm, for example, 850 nm, then the height of the support pillars 3 is greater than 850 nm, but the present disclosure is not limited thereto. The height of the nano-pillars 41 may be set according to practical requirements, and the height of the support pillars 3 need only be greater than the height of the nano-pillars 41.

It should be noted that if the distribution patterns of the nano-pillars 41 are different from each other among the metasurface structural units 4, the corresponding optical effects are different.

It should be noted that, the dimensions of the designed metasurface structural units 4 are all on the order of nanometers, and the processing error of each geometric parameter needs to be less than 10 nm, for even smaller metasurface structural units 4, the processing error needs to be controlled within 5 nm, thus the ordinary photolithography technology can no longer meet the processing requirements of the metasurface structural units 4, and a more accurate electron beam lithography technology is adopted in preparing the metasurface structural units 4. Electron beam lithography is a technique that forms exposure patterns by utilizing the sensitivity of some high molecular polymers to electrons. In the process of exposure, different from the large area exposure of the substrate surface performed directly through a mask in the photolithography system, localized exposure is performed by means of an electron beam. The electron beam lithography process mainly includes three steps: spin-coating an electron beam resist, exposure (the area irradiated by an electron beam is an electron beam resist removal area), and development.

Illustratively, the nano-pillars 41 have a refractive index greater than that of the gas layer.

Illustratively, a difference between the refractive index of the nano-pillars 41 and the refractive index of the gas layer 5 is greater than 0.7.

In the related art, the metasurface structure includes a substrate and nano-pillars disposed on the substrate. In order to realize light modulation, the metasurface structure generally needs to be encapsulated for protection. In order not to destroy the light modulation function of the metasurface, a layer of low refractive index adhesive material is generally coated on the surface of the nano-pillars, and then the cover glass is attached for protection. At present, the refractive index range of the adhesive materials that can be traced is 1.35-1.65, the nano-pillars are made of silicon nitride, and the difference of the refractive index Δn between the low refractive index adhesive material and the nano-pillars is less than 0.7. The difference between the refractive index of low refractive index adhesive material and the refractive index of the nano-pillars is related to the depth-width ratio of the nano-pillars. The greater the difference between the refractive index of low refractive index adhesive material and the refractive index of the nano-pillars, the smaller the depth-width ratio of the nano-pillars. When Δn<0.7, to ensure the diameter of the end face of the nano-pillar, the nano-pillar is relatively high, and tends to collapse, and the corresponding process requirements are strict and the adjustable range is small. In the embodiment of the present disclosure, the difference between the refractive index of the nano-pillars 41 and the refractive index of the gas layer 5 is greater than 0.7, thus broadening the range of process adjustability. For example, the height of the nano-pillar 41 can be reduced while the end face diameter of the nano-pillar 41 remains unchanged, thereby reducing the processing difficulty.

As long as it is ensured that the difference between the refractive index of the nano-pillars and the refractive index of the gas layer 5 is greater than 0.7, the specific materials from which the first medium and the second medium are made can be selected according to actual needs: for example, the nano-pillars 41 are made of silicon nitride (namely, the nano-pillars are made of silicon nitride), and the gas layer 5 is an air layer. The refractive index of air is 1.0, and the refractive index of silicon nitride is 2.0, so that the refractive index difference Δn between the first medium and the second medium can reach 1.0, which greatly broadens the range of process adjustability. In addition, the use of the air layer as the second medium can save materials and reduce costs.

Illustratively, the thickness of the substrate 1 is a preset value, such that a light-emitting surface of the display panel main body is located on a focal plane of the metasurface structure.

By adopting the above scheme, the light rays emitted from the metasurface structure are parallel, while the optical effect is ensured.

It should be noted that the selection of the thickness of the substrate is related to the focal length of the metasurface structure. For example, if the focal length of the metasurface structure is 3 μm, then the thickness of the substrate is 3 μm.

It should be noted that, the integration of the light modulation structure and the display panel main body may be achieved by manufacturing the display panel main body and the light modulation structure separately, attaching the substrate to the light-emitting side of the display panel main body, and then assembling the display panel main body with the light modulation structure; or may be achieved by directly forming the light modulation structure on the light-emitting side of the display panel main body, wherein the substrate 1 may be formed by coating or the like, but the present disclosure is not limited thereto.

Illustratively, a thickness of the substrate 1 is greater than that of the metasurface structure in the direction perpendicular to the substrate 1.

Illustratively, a distance between two adjacent metasurface structural units 4 is greater than a distance between two adjacent nano-pillars 41 in each of the metasurface structural units 4.

Illustratively, the nano-pillars 41 in each of the metasurface structural units 4 are symmetrically arranged about a center of the corresponding metasurface structural unit 4, but the present disclosure is not limited thereto, and the specific arrangement pattern can be set according to the required optical effect.

Illustratively, a cross-section shape of the nano-pillars 41 in the direction perpendicular to the substrate 1 includes one or more of a rectangle, a circular arc, and a trapezoid.

It should be noted that, the cross-section shape of the nano-pillars 41 may be the same or different across different metasurface structural units 4.

Illustratively, in the direction perpendicular to the substrate 1, the cross-section shape of the nano-pillars 41 is rectangle, the slope angle of the nano-pillars 41 is 90 degrees, the cross-section shape of the support pillars 3 is trapezoid, the slope angle a of the support pillars 3 is less than the slope angle of the nano-pillar 41. With reference to FIG. 14, the angle a is an inner angle formed by a side edge and a bottom edge of the cross-section shape of the support pillar 3.

Illustratively, an area of an orthographic projection of the support pillar 3 onto the substrate 1 is greater than an area of an orthographic projection of the nano-pillar 41 onto the substrate 1.

Illustratively, each of the pixels includes a plurality of sub-pixels 7, each of the metasurface structural units 4 includes a plurality of sub-structural units, each of the sub-structural units includes a plurality of nano-pillars 41 spaced apart, and the plurality of sub-structural units are in one-to-one correspondence with the plurality of sub-pixels 7.

The display panel shown in FIGS. 5 and 6 includes a display panel main body 6, a plurality of sub-pixels 7 located on the display panel main body 6, and the metasurface structure disposed on the light-emitting side of the plurality of sub-pixels 7.

Illustratively, the pixel includes a plurality of different colored sub-pixels 7; and the nano-pillars 41 within the metasurface structural unit that correspond to the different colored sub-pixels 7 respectively have different arrangement spacings.

Illustratively, the pixel includes a red sub-pixel, a green sub-pixel, and a blue sub-pixel;
the metasurface structural unit includes a first sub-structural unit corresponding to the red sub-pixel, and the arrangement spacing of the plurality of nano-pillars in the first sub-structural unit is 300-700 nm;
the metasurface structural unit includes a second sub-structural unit corresponding to the green sub-pixel, and the arrangement spacing of the plurality of nano-pillars in the second sub-structural unit is 270-550 nm;
the metasurface structural unit includes a third sub-structural unit corresponding to the blue sub-pixel, and the arrangement spacing of the plurality of nano-pillars in the third sub-structural unit is 230-450 nm.

The function of the support pillar 3 is to support the substrate 1 and the cover layer 2, keep the distance between the substrate 1 and the cover layer 2, and avoid contact between the cover layer 2 and the nano-pillars 41, so as to avoid affecting the optical effect. Therefore, the support pillars 3 may be positioned as long as the position of the support pillars 3 does not impact the arrangement of the nano-pillars 41. The following are several arrangement modes of the support pillars 3 in the embodiments.

Referring to FIGS. 3 and 5, illustratively, at least one support pillar 3 is disposed on a peripheral edge of each metasurface structural unit 4. In an implementation, at least one support pillar 3 is disposed between any two adjacent metasurface structural units 4, and at least one support pillar 3 is disposed on the periphery of each of the first metasurface structural units 4 located at the edge of the substrate 1, which can effectively keep the distance between the substrate 1 and the cover layer 2 and ensure the overall flatness of the substrate 1 and the cover layer 2.

In some implementations, the support pillars 3 on the outside edges of a row of the first metasurface structural units 4 parallel to any one edge of the substrate 1 may be connected along the extension direction of the corresponding edge to form a supporting dam, which is beneficial to the formation of the air layer.

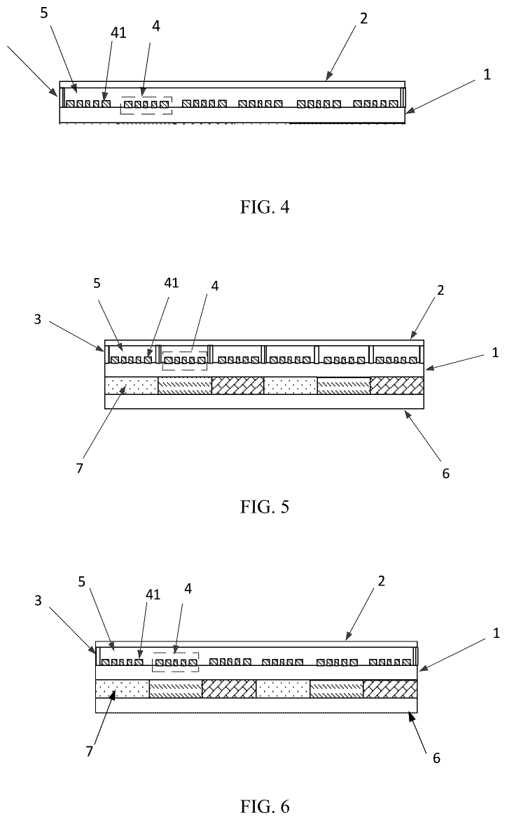

Referring to FIGS. 4 and 6, illustratively, the substrate 1 includes a central area where multiple metasurface structural units 4 are disposed, and an edge region at the periphery of the central area, and a plurality of support pillars 3 are uniformly disposed in the edge area.

The support pillars 3 are located in the peripheral area of the substrate 1, which reduces the space occupied by the support pillars 3 and effectively avoids affecting the optical effect.

The plurality of support pillars 3 are connected into an integral structure, so as to form a supporting dam at the periphery of the metasurface structural units 4, which is beneficial to the formation of the air layer.

Illustratively, the support pillars 3 are made of the same material as the nano-pillars 41.

It should be noted that the support pillars 3 and the nano-pillars 41 can be made of the same material or different materials. If the support pillars 3 and the nano-pillars 41 are made of the same material, for example, both the support pillars 3 and the nano-pillars 41 are made of a silicon nitride material, then the support pillars 3 and the nano-pillars 41 can be formed at the same time, which simplifies the process and is equivalent to forming a new type of metasurface structure different from the conventional metasurface structure.

Illustratively, the substrate 1 and the cover layer 2 are encapsulated together using a frame sealing adhesive around the substrate 1 and the cover layer 2.

The substrate 1 and the cover layer 2 are encapsulated together by the frame sealing adhesive, so that the space between the substrate 1 and the cover layer 2 forms a sealed space, which ensures the refractive index difference between the air layer and the metasurface structural units 4 and ensures the optical effect of the metasurface structure.

Illustratively, the cover layer 2 is made of a transparent material.

The metasurface structure serves to act optically on the light passing through the metasurface structure, resulting in corresponding optical effects, such as brightness enhancement, etc. The cover layer 2 is made of the transparent material, which can increase the light transmittance.

It should be noted that the specific structural forms of the cover layer 2 can be varied, and the materials thereof can also be varied. For example, the cover layer 2 may be a cover glass, but the present disclosure is not limited thereto.

Illustratively, the substrate 1 may also be made of a transparent material.

The embodiments of the present disclosure also provide a method for manufacturing the above display panel, and the method specifically includes;
providing the display panel main body and the light modulation structure;
attaching the light modulation structure to a light-emitting side of the display panel main body.

According to the above method, the display panel main body and the light modulation structure are attached and assembled after the display panel main body and the light modulation structure are manufactured separately, but the present disclosure is not limited to the method. For example, the light modulation structure can be directly formed on the display panel main body. Specifically, the method for manufacturing the display panel can include the following steps;
forming the substrate on the display panel main body;
forming the metasurface structure on the substrate, where the metasurface structure includes a plurality of metasurface structural units arranged in an array, the plurality of metasurface structural units are in one-to-one correspondence with a plurality of pixels on the display panel main body, and each of the metasurface structural units includes a plurality of nano-pillars;
forming a plurality of support pillars on the substrate;
forming, on the substrate, a filling layer filling between adjacent nano-pillars, between adjacent support pillars, and/or between the nano-pillar and support pillar which are adjacent to each other, a side surface of the filling layer away from the substrate being flush with an end surface of the support pillars away from the substrate, where the filling layer is formed using a pore-forming agent material, with reference to FIG. 12;
forming the cover layer on the filling layer, with reference to FIG. 13;
heating to a preset temperature, causing the filling layer to gasify and escape through the cover layer while outside air enters between the substrate and the cover layer; and
forming a frame sealing adhesive around the substrate and the cover layer, and encapsulating the substrate and the cover layer together.

It should be noted that the material of the filling layer 8 is not limited to the pore-forming agent material, as long as the filling layer 8 can be gasified under preset conditions.

The filling layer 8 is made of a thermally decomposable material or a mixture of materials that can decompose at a temperature which will not cause damage to the substrate 1, the cover layer 2, and the metasurface structural units 4. After the cover layer 2 is disposed on the filling layer 8, the whole panel is heated to a temperature at which the filling layer 8 can decompose, which causes the filling layer 8 to gasify. The cover layer 2 is sufficiently porous to allow gas formed as a result of the gasification of the filling layer 8 to pass through the cover layer 2 to leave the accommodation space enclosed by the substrate 1, the cover layer 2, and the support pillars 3, and to allow air to pass through the cover layer 2 into the accommodating space to form the air layer.

Illustratively, the pore-forming agent material is propylene carbonate, and when heated to 120-300 degrees, the filling layer 8 will gasify and escape through the cover layer 2, and the outside air is allowed to enter between the substrate 1 and the cover layer 2.

The pore-forming agent material can be propylene carbonate (PPC), which can decompose in inert atmosphere or air without leaving obvious residue. Typically, the expected decomposition temperature of the pore-forming agent materials is between 120° C. and 230° C. If the decomposition temperature between 200° C. and 300° C. is used, the pore-forming agent can be replaced by air in a short time. If the decomposition temperature must be lowered, additives can be added or the baking time can be extended. Through proper combination of materials, film thickness, and baking time, a decomposition temperature between 120° C. and 160° C. is possible to achieve. The baking temperature and temperature ramp rate need to be carefully controlled so as not to leave obvious residues, and so that the gas release rate of the pore-forming agent is controlled so as not to cause damage, such as bursting, sagging and cracking, to the SiOx cap layer.

The method of forming the light modulation structure is not limited to the abovementioned. For example, in one implementation, with reference to FIGS. 3 to 13, the step of providing the display panel main body and the light modulation structure includes manufacturing the light modulation structure, which specifically includes;
providing a substrate 1 and a cover layer 2;
forming on the substrate 1 a metasurface structure (the metasurface structure is prepared using an electron beam lithography (EBL) technique) including a plurality of metasurface structural units 4 arranged in an array, where each metasurface structural unit includes a plurality of nano-pillars spaced apart;
disposing support pillars 3 on the substrate 1 or the cover layer 2, where the height of the support pillars 3 is greater than that of the nano-pillars 41 in a direction perpendicular to the substrate 1 (the support pillars are prepared using an electron beam lithography (EBL) technique);
aligning and assembling the substrate 1 with the cover layer 2, such that the support pillars 3 support the substrate 1 and the cover layer 2 in between, and the metasurface structure is located between the substrate 1 and the cover layer 2;
forming a frame sealing adhesive around the substrate 1 and the cover layer 2, and encapsulating the substrate 1 and the cover layer 2 together.

In some implementations, the disposing the support pillars 3 on the substrate 1 or the cover layer 2 specifically includes: directly forming the support pillars 3 on the substrate 1 (referring to FIGS. 8 and 10), and then directly fitting the cover layer 2 onto the substrate 1 in the step of aligning and assembling the substrate 1 with the cover layer 2.

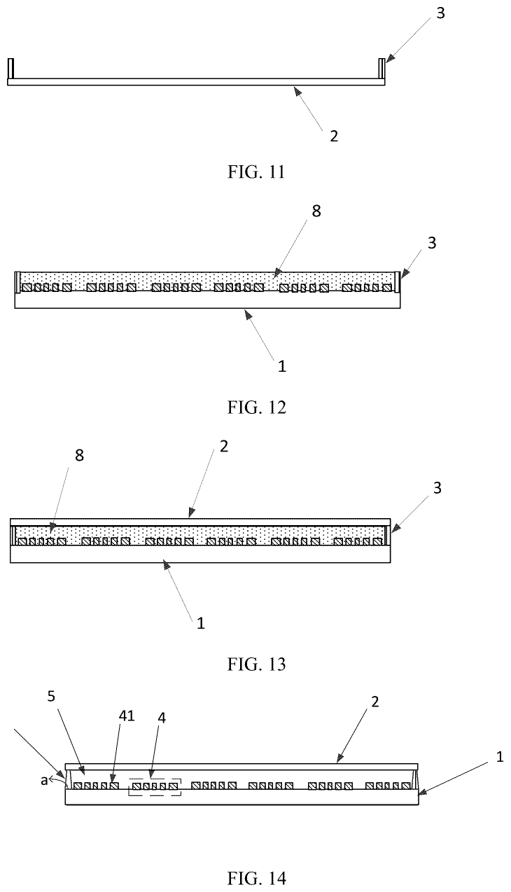

In some implementations, the disposing the support pillars 3 on the substrate 1 or the cover layer 2 specifically includes: forming the support pillars 3 on the cover layer 2 (referring to FIGS. 9 and 11), thus, in the step of aligning and assembling the substrate 1 with the cover layer 2, the cover layer 2 needs to be inverted so that the side on which the support pillars 3 are formed faces the substrate 1, and then the substrate 1 and the cover layer 2 are assembled.

Illustratively, the support pillars 3 are located at the edges of the substrate 1 (referring to FIGS. 10 and 11), or at least one support pillar 3 is disposed at the periphery of each metasurface structural unit 4 (referring to FIGS. 8 and 9).

When the light modulation structure is integrated with a display panel and is disposed on the light-emitting side of the display panel main body, the plurality of metasurface structural units 4 are in one-to-one correspondence with a plurality of pixels or a plurality of sub-pixels 7 on the display panel main body. In the implementation where at least one support pillar 3 is disposed between two adjacent metasurface structural units 4, the support pillars 3 are located between adjacent pixels or adjacent sub-pixels 7, so as to avoid affecting the display of the display panel.

It should be noted that the cover layer 2 is made of a transparent material, and the cover layer 2 is made of a relatively sturdy solid-state material. The thickness of the cover layer 2 is a preset value, so that the cover layer 2 will not collapse after the filling layer 8 is gasified.

Illustratively, the cover layer 2 is made of SiOx.

It can be understood that the above implementations are only exemplary implementations adopted for explaining the principles of the present disclosure, but the present disclosure is not limited thereto. It is obvious to those skilled in the art that various variations and improvements can be made without departing from the spirit and essence of the present disclosure, and these variations and improvements are also regarded as falling within the scope of the present disclosure.

1. A display panel, comprising a display panel main body and a light modulation structure located on a light-emitting side of the display panel main body; wherein
the display panel main body comprises a plurality of pixels arranged in an array;
the light modulation structure comprises a substrate, a first medium, a second medium, and a cover layer, the first medium and the second medium being disposed between the substrate and the cover layer;
the first medium comprises a metasurface structure, the metasurface structure comprises a plurality of metasurface structural units arranged in an array on a surface of the substrate close to the cover layer, the plurality of metasurface structural units are in one-to-one correspondence with the plurality of pixels, and at least one of the metasurface structural units comprises a plurality of nano-pillars spaced apart;
the second medium comprises a gas layer filling between the substrate and the cover layer;
the substrate and the cover layer are spaced from each other by support pillars, and a height of the support pillars is greater than a height of the nano-pillars in a direction perpendicular to the substrate.

2. The display panel according to claim 1, wherein a refractive index of the nano-pillars is greater than a refractive index of the gas layer.

3. The display panel according to claim 2, wherein a difference between the refractive index of the nano-pillars and the refractive index of the gas layer is greater than 0.7.

4. The display panel according to claim 1, wherein a light-emitting surface of the display panel main body is located on a focal plane of the metasurface structure.

5. The display panel according to claim 4, wherein a thickness of the substrate is greater than a thickness of the metasurface structure in the direction perpendicular to the substrate.

6. The display panel according to claim 1, wherein a distance between two adjacent metasurface structural units of the metasurface structural units is greater than a distance between two adjacent nano-pillars of the nano-pillars in each of the metasurface structural units.

7. The display panel according to claim 1, wherein the nano-pillars in each of the metasurface structural units are symmetrically arranged about a center of the corresponding metasurface structural unit.

8. The display panel according to claim 1, wherein a cross-section shape of the nano-pillars in the direction perpendicular to the substrate comprises one or more of a rectangle, a circular arc, and a trapezoid.

9. The display panel according to claim 1, wherein in the direction perpendicular to the substrate, a cross-section shape of the nano-pillars is a rectangle, a cross-section shape of the support pillars is a trapezoid, and a slope angle of the support pillars is less than a slope angle of the nano-pillars.

10. The display panel according to claim 1, wherein an area of an orthographic projection of the support pillar onto the substrate is greater than an area of an orthographic projection of the nano-pillar onto the substrate.

11. The display panel according to claim 1, wherein each of the pixels comprises a plurality of sub-pixels, each of the metasurface structural units comprises a plurality of sub-structural units, at least one of the sub-structural units comprises a plurality of nano-pillars spaced apart, and the plurality of sub-structural units are in one-to-one correspondence with the plurality of sub-pixels.

12. The display panel according to claim 11, wherein the pixel comprises a plurality of different colored sub-pixels; and the nano-pillars within the metasurface structural unit that correspond to the different colored sub-pixels respectively have different arrangement spacings.

13. The display panel according to claim 12, wherein the pixel comprises a red sub-pixel, a green sub-pixel, and a blue sub-pixel;
the metasurface structural unit comprises a first sub-structural unit corresponding to the red sub-pixel, and the arrangement spacing of the plurality of nano-pillars in the first sub-structural unit is 300-700 nm;
the metasurface structural unit comprises a second sub-structural unit corresponding to the green sub-pixel, and the arrangement spacing of the plurality of nano-pillars in the second sub-structural unit is 270-550 nm;
the metasurface structural unit comprises a third sub-structural unit corresponding to the blue sub-pixel, and the arrangement spacing of the plurality of nano-pillars in the third sub-structural unit is 230-450 nm.

14. The display panel according to claim 11, wherein at least one of the support pillars is disposed on a peripheral edge of at least one of the sub-structural units.

15. The display panel according to claim 11, wherein the substrate comprises a central area where multiple metasurface structural units of the metasurface structural units are disposed, and an edge region at the periphery of the central area, and multiple support pillars of the support pillars are uniformly disposed in the edge area.

16. The display panel according to claim 1, wherein the nano-pillars are made of silicon nitride, and the gas layer is an air layer.

17. The display panel according to claim 16, wherein the support pillars are made of the same material as the nano-pillars.

18. A method for manufacturing a display panel, wherein the display panel comprises a display panel main body and a light modulation structure located on a light-emitting side of the display panel main body;
the display panel main body comprises a plurality of pixels arranged in an array;
the light modulation structure comprises a substrate, a first medium, a second medium, and a cover layer, the first medium and the second medium being disposed between the substrate and the cover layer;
the first medium comprises a metasurface structure, the metasurface structure comprises a plurality of metasurface structural units arranged in an array on a surface of the substrate close to the cover layer, the plurality of metasurface structural units are in one-to-one correspondence with the plurality of pixels, and at least one of the metasurface structural units comprises a plurality of nano-pillars spaced apart;
the second medium comprises a gas layer filling between the substrate and the cover layer;
the substrate and the cover layer are spaced from each other by support pillars, and a height of the support pillars is greater than a height of the nano-pillars in a direction perpendicular to the substrate;
wherein the method specifically comprises;
providing the display panel main body and the light modulation structure;
attaching the light modulation structure to the light-emitting side of the display panel main body; or
forming the substrate on the display panel main body;
forming the metasurface structure on the substrate, wherein the metasurface structure comprises the plurality of metasurface structural units arranged in an array, the plurality of metasurface structural units are in one-to-one correspondence with the plurality of pixels on the display panel main body, and at least one of the metasurface structural units comprises the plurality of nano-pillars;
forming the support pillars on the substrate;
forming on the substrate a filling layer filling between the adjacent nano-pillars, between the adjacent support pillars, and/or between the adjacent nano-pillar and support pillar, a side surface of the filling layer away from the substrate being flush with an end surface of the support pillars away from the substrate, wherein the filling layer is formed using a pore-forming agent material;
forming the cover layer on the filling layer;
heating to a preset temperature, causing the filling layer to gasify and escape through the cover layer while outside air enters between the substrate and the cover layer; and
forming a frame sealing adhesive around the substrate and the cover layer, and encapsulating the substrate and the cover layer together.

19. The display panel according to claim 1, wherein at least one of the support pillars is disposed between any two adjacent metasurface structural units of the metasurface structural units, and at least one of the support pillars is disposed on the periphery of each of first metasurface structural units located at an edge of the substrate.

20. The display panel according to claim 15, wherein the multiple support pillars are connected into an integral structure to form a supporting dam at the periphery of the metasurface structural units.
